(19) United States
(12) Patent Application Publication
(10) Pub. No.: US 2009/0268589 A1
(43) Pub. Date: Oct. 29, 2009

(54) INFORMATION RECORDING UNIT AND RECORDING CONDITION CALIBRATION METHOD

(76) Inventors: Masaki NAKANO, Tokyo (JP); Masatsugu OGAWA, Tokyo (JP)

Correspondence Address: NEC CORPORATION OF AMERICA, 6535 N. STATE HWY 161, IRVING, TX, 75039, US

(21) Appl. No.: 12/411,688

(22) Filed: Mar. 26, 2009

(30) Foreign Application Priority Data
Apr. 23, 2008 (JP) 2008-112405

(51) Int. Cl. G11B 7/00

(52) U.S. Cl. 369/116; G9B/7

(57) ABSTRACT

A method for calibrating a recording condition in an information recording unit includes: heating a recorded data pattern recorded on the information recording medium; reproducing the recorded data pattern after the heating, to measure a reproduced-signal quality; and determining a recording condition based on the measured reproduced-signal quality.

### TECHNICAL FIELD

The present invention relates to an information recording unit and, more particularly, to an information recording unit that performs recording on an optical information recording medium for which a mark is formed by optical beam irradiation. The present invention also relates to a method for calibrating the recording condition used in the information recording unit.

### BACKGROUND OF THE INVENTION

An optical disc drive (optical information recording/reproducing unit) uses a laser beam to write (record) and read (reproduce) information on an optical disc. The optical disc drive is generally used as, for example, a peripheral device of an information processing unit, and an AV (audio visual) apparatus. The optical disc drive irradiates the laser beam onto a recording film of the optical disc, and changes the characteristic of the substance in the recording film, to thereby form a recorded mark in the optical disc. The optical disc drive forms the recorded mark in the optical disc based on input recording data, thereby storing therein desired information.

In order to form suitable recorded marks in accordance with the recording data, it is important to control the optical power of the laser beam irradiated onto the recording film, i.e., to control the heating power applied to the recording film. If the heating power applied to the recording film is insufficient, for example, a suitable recorded mark cannot be formed. On the contrary, if an excessive heating power is applied thereto, the mark formed thereby has an inappropriate shape. In addition, the mark formed by the excessive heating power may exert an adverse influence on an adjacent recorded mark.

It is therefore important for the optical disc drive to suitably control the output of the laser beam upon forming the mark. The control of laser beam is performed by changing the waveform shape of optical beam, which is referred to as recording strategy. The waveform, i.e., recording strategy defines an amplitude of the laser beam that determines levels of the recording-use power including a peak power Pw, a bias power Pb, a bottom power Pbtm etc., and a pulse width of the laser beam (along the time axis) that determines the time length of the optical irradiation during the mark formation.

The recording strategy uses a variety of waveform shapes having respective power levels and pulse shapes, which are selected depending on the medium for which the mark is recorded. A DVD-R, for example, which is a write-once disc and thus allows the recording only once thereon, uses a rectangular recording strategy. A DVD-RW, which is a rewritable disc and thus allows repeated overwriting thereon, uses a multiple-pulse recording strategy.

In FIG. 21, waveforms (a) to (f) exemplify a data pattern to be recorded and a variety of recording strategies used for recording the data pattern. More specifically, the recording strategies of (b) to (f) are used for recording the data pattern shown in (a) including a mark and a space. The waveform of (b) configures a pulse-train recording strategy having two power levels Pw and Pb. This recording strategy irradiates a plurality of times two power levels including a bias power Pb and a peak power Pw onto the position corresponding to the mark 150. The waveform of (c) configures a simple rectangular recording strategy, wherein the laser beam power is raised from the bias power Pb to the peak power Pw at the position corresponding to the mark 150.

The waveform of (d) in FIG. 21 configures a specific rectangular recording strategy having an intensified front edge portion. This recording strategy raises the laser beam power from the bias power Pb to the peak power Pw at the position corresponding to the front edge portion of the mark, and thereafter lowering the power from the peak power Pw to an intermediate power Pm, referred to as middle power, during the rest of the mark, thereby intensifying the front edge portion of the rectangle. The waveform of (e) configures another specific rectangular recording strategy having intensified front and rear edge portions of the rectangle. This recording strategy modifies the waveform of (d) by raising the laser beam power up to the peak power Pw at the rear edge portion of the rectangle.

The waveform of (f) configures a pulse-train recording strategy having three power levels. This recording strategy changes the laser beam power among the bottom power Pbtm, peak power Pw and another intermediate power Pe. This intermediate power Pe is irradiated onto the position corresponding to the space and has a function of erasing an existing mark to form a space. Thus, this intermediate power Pe is referred to as erasing power. This power corresponding to the space may be sometimes referred also to as bias power collectively.

HD DVDs (high-definition DVDs), which are next-generation DVDs, including HD DVD-RW and HD DVD-RAM mainly use the multiple-pulse recording strategy, so long as the HD DVDs are of up to 2×speed. The recording strategy largely affects the recording/reproducing performance of the optical disc. Thus, a variety of calibration techniques have been used for calibrating the recording strategy.

Description will now be given to the performance index used for calibration of recording parameters in the recording condition under which the mark is recorded on the optical disc. It is assumed here that the calibration is performed on the recording-use power, which is the power used for recording a mark or marks. A blank disc generally includes an area, referred to as drive test zone, used for calibration of the recording power for the optical disc. The optical disc drive uses this area, as desired, to calibrate the recording-use power.

The optical disc drive, upon loading of a blank disc, reads out information such as the type, manufacture etc. of the disc. The optical disc drive performs calibration of the recording power, referred to as OPC (optimum power control), based on a recommended recording strategy that is indicated by the information read from the medium. In calibration of the recording power, there may be a case where the information stored in the disc drive corresponding to each medium is used without using the information read out from the medium.

Known techniques of calibrating the recording-use power include a beta technique that inspects asymmetry obtained by reproduced amplitude of a long mark and short mark to find a β-value, a gamma technique that judges the degree of saturation of the amplitude of the recorded mark. In general, the beta technique is used in the DVD-R, whereas the gamma technique is used in the DVD-RW and DVD+RW.

In the beta technique, the β-value is calculated based on a reference value Ref acquired by reproducing a short mark, and the peak level and bottom level of a long mark. FIG. 22 exemplifies calculation of the β-value. In this example, the long mark is a 11 T mark and the short mark is a 3 T mark. The reference value Ref is set at the center of reproduced amplitude of the 3 T mark. The reference value Ref is calculated from the reproduced waveform of the 3 T mark, and a difference “A” between the reference value Ref and the peak level of the 11 T mark as well as a difference “B” between the reference value Ref and the bottom level of the 11 T mark is calculated. Thereafter, the β-value is calculated from the following formula-1:

β=0.5×(A−B)/(A+B) (1)

The β-value is calculated using the signal level of the minimum value, maximum value, average level (average voltage) etc. of each pattern. The β-value represents a deviation between the center of the maximum amplitude and the center of the minimum amplitude, and is used as an index equivalent to asymmetry. The β-value has a correlation with the index of the signal quality, such as jitter a and number of errors, that is used as an evaluation index of the recorded signal quality. The β-value does not assure the performance by the value itself, and is used as a target value after determining the correspondence between the β-value and the absolute index of the performance, such as the number of errors, error rate and jitter. Since an error correction processing, if performed, cannot correct the error in general when the jitter σ is equal to or above 15%, it is needed to calibrate the recording parameters so that the jitter σ assumes 15% or below.

The technique for the next-generation DVD, such as HD DVD, having a higher recording density, uses PRML (partial-response maximum-likelihood) detection. In the HD DVD, it is difficult to measure the jitter itself. Therefore, a PRSNR (partial-response signal-to-noise ratio) is introduced as the performance index for the HD DVD (for example, refer to Non-Patent Literature-1). The PRSNR is used as the evaluation index of the signal quality that replaces the jitter. The PRSNR is an SNR value used in the PRML detection. The PRSNR can be converted into the error rate, and a higher PRSNR means a higher signal quality. For a safe operation of the disc drive, it is known that the PRSNR should assume 15 or above in the performance. There are other techniques of evaluating the quality of the reproduced waveform, such as the technique of calculating the error rate and the number of error bytes. These indexes represent the absolute value of the performance. A lower (smaller) error rate or jitter means a higher performance.

The characteristics required of the recordable optical disc include a characteristic wherein the surrounding environment does not change the optical disc itself or the characteristics thereof. This is referred to as weather resistance. The weather resistance includes archival characteristic (archival life), shelf characteristic (shelf life), archival over-writing characteristic (over-writing shelf), etc. The evaluation of these characteristics is performed by an accelerated environmental test wherein heat and humidity are forcibly applied to the optical disc for which data is already recorded.

Description will be given to detail of the weather resistance. The archival characteristic relates to the durability and stability of the recorded data that determines the period or duration during which the data once recorded can exist stably. If the archival characteristic is deteriorated, reproduction of the recorded data is impossible. The shelf characteristic relates to the duration during which the same recording condition continues unchanged for an unrecorded area. If the shelf characteristic is deteriorated, a suitable recording cannot be achieved. The archival overwriting characteristic relates to the duration during which the medium enables a suitable overwriting thereon. If the archival overwriting characteristic is deteriorated, it is impossible to perform a suitable overwriting on the medium.

Some proposals have been presented heretofore for improving the weather resistance of the medium. Patent Publication-1 describes a technique of introducing additives in the recording film of the optical medium. Patent Publication-2 describes a technique of correcting the writing strategy so as to reduce the recorded jitter to a minimum if the optical disc is deteriorated with time. Patent Publication-3 describes a technique of recording two types of specific data pattern and reproducing the same. In Patent Publication-3, the recording irradiation power is determined so that the difference between the asymmetries of the reproduced signals from both the specific data patterns is less than 0.02, to thereby select the recording condition that provides a higher shelf characteristic.

Patent Publication-4 discloses a recording performed in a drive test area while changing the DC power, followed by reproducing the recorded area, to obtain the power Pd that provides a maximum reflectance change. The peak power Pw and bias power Pb are obtained by multiplying the resultant power Pd by a specific coefficient. It is recited in this publication that such a operation is conducted each time there occurs a factor that changes the recording condition of the optical disc. Patent Publication-5 describes that reproduction using a reproducing power higher than a normal reproducing power is performed at least once after a recording. It is recited in this publication that this reproduction suppresses deterioration of the archival over-writing characteristic of a phase-change optical disc.

Patent Publication-6 discloses a recording condition setting technique that prevents an increase of error rate after deterioration with age in a write-once optical disc including an organic-pigment recording film for which a 780-nm-wavelength light is used. It is recited in this publication that recording is performed using a laser beam having an irradiation power of 0.5 to 0.93 times the laser irradiation power that provides a minimum error rate in an experiment. It is also recited in this publication that the error rate is measured after exposing the medium to a virtual environmental test.

The documents as recited in this text include:

Patent Publication-1 (JP-5-124353A);

Patent Publication-2 (JP-2007-294047A);

Patent Publication-3 (JP-2006-040337A),

Patent Publication-4 (JP-2797733B);

Patent Publication-5 (JP-2002-8240A); and

Patent Publication-6 (JP-2667445B).

Non-Patent Literature-1 (Japanese Journal of Applied Physics Vol.43, No.7B, 2004, pp.4859-4862 “Signal-to-Noise Ratio in a Partial-Response-Maximum-Likelihood Detection” S. OHKUBO et al.

In general, an accelerated environmental test is used for the weather resistance evaluation, and a particular equipment is required therein. The accelerated environmental test requires a longer time that may exceed hundreds of hours, for example. For this reason, a problem arises that the actual recording/reproducing unit cannot be used for the weather resistance evaluation. A variety of techniques proposed heretofore correspond to the shelf characteristic and archival over-writing characteristic as the recording characteristic. On the other hand, the technique relating to maintaining the archival characteristic that is important as the weather resistance depends solely on the characteristic improvement of the medium itself and is not directed to the countermeasure used in the disc drive.

The improvement for a higher density recording has been remarkably developed in the optical disc, and thus requires a higher accuracy in the calibration of parameters including recording-use power. In addition, a recording/reproducing unit has appeared that uses a laser beam having a wavelength of around 405 nm, which is accompanied by a characteristic change of the optical disc. Thus, a situation arises wherein the existing technique cannot be necessarily applied therein. In particular, the medium including an organic-pigment recording film is known to have a higher wavelength dependency, and thus the problem that the existing technique cannot be applied thereto is serious therein.

### SUMMARY OF THE INVENTION

It is an object of the present invention to provide a recording-condition calibration method which is capable of selecting a suitable recording condition in a short period of time with a simple procedure, as well as an information recording unit that uses such a method.

The present invention provides a recording condition calibration method including: heating a first recorded data pattern recorded on the information recording medium; reproducing the first recorded data pattern after the heating, to measure a reproduced-signal quality; and determining a desired recording condition based on the measured reproduced-signal quality.

The present invention also provides an information recording/reproducing unit including a parameter calibration unit that heats a first recorded data pattern recorded on the information recording medium, reproduces the first recorded data pattern after the heating, to measure a reproduced-signal quality, and determines a desired recording condition based on the measured reproduced-signal quality.

The above and other objects, features and advantages of the present invention will be more apparent from the following description, referring to the accompanying drawings.

### BRIEF DESCRIPTION OF THE DRAWINGS

FIG. 1 is a block diagram showing an information recording/reproducing unit according to a first exemplary embodiment of the present invention.

FIG. 2 is a block diagram showing the configuration of the RF circuit shown in FIG 1.

FIG. 3 is a flowchart showing the procedure of calibrating the recording condition.

FIG. 4(a) is a data pattern diagram showing a mark and a space to be formed by a recording operation, and FIG. 4(b) is a waveform diagram of a (k−1)-pulse train.

FIG. 5 is a table showing a parameter list.

FIG. 6(a) is a diagram showing recorded areas, FIG. 6(b) is a waveform diagram showing a detection signal detecting a recorded area, and FIG. 6(c) is a waveform diagram showing an example of the laser power for heating.

FIG. 7(a) is a waveform diagram of a detection signal detecting a recorded area, and FIGS. 6(b) and (c) are waveform diagrams showing other examples of the laser power for heating.

FIG. 8 is a graph showing the results of measuring the signal quality.

FIG. 9 is a graph showing an example of determining the recording-use power from a plurality of parameters.

FIG. 10 is a graph showing the results of measuring a reproduced-signal quality after the accelerated environmental test.

FIG. 11 is a graph showing the results of measuring the PRSNR before the accelerated environmental test.

FIG. 12 is a flowchart showing the procedure of determining the heating power.

FIG. 13(a) is a waveform diagram showing an example of the laser power for heating, and FIG. 13(b) is a waveform diagram showing results of measuring the reproduced-signal quality.

FIG. 14 is a graph showing an example of the results of measuring the PRSNR for different amounts of heating power.

FIG. 15 is a flowchart showing the procedure of setting the recording-use power.

FIG. 16 is a table showing the recording-use parameters.

FIG. 17 is a graph showing the results of measuring the PRSNR.

FIG. 18 is a graph showing the results of measuring the PRSNR for the case of using a variable step.

FIG. 19 is a graph showing the results of measuring the bit error rate.

FIG. 20 is a graph showing the results of measuring the number of PI error bytes.

FIG. 21 is a waveform diagram showing the recording pattern and a variety of recording strategies.

FIG. 22 is a waveform diagram exemplifying a method for calculating the β-value.

### DESCRIPTION OF EMBODIMENTS

The basic configuration of the recording condition calibration method of the present invention includes heating a first recorded data pattern recorded on the information recording medium; reproducing the first recorded data pattern after the heating, to measure a reproduced-signal quality; and determining a desired recording condition based on the measured reproduced-signal quality.

The basic stricture of the information recording/reproducing unit of the present invention includes a parameter calibration unit that heats a first recorded data pattern recorded on the information recording medium, reproduces the first recorded data pattern after the heating, to measure a reproduced-signal quality, and determines a desired recording condition based on the measured reproduced-signal quality.

In the method and information recording unit of the present invention, a recoding-use condition that records a mark having a superior archival characteristic can be obtained. The information recording unit may be a dedicated recording unit, or may be a recording and reproducing unit.

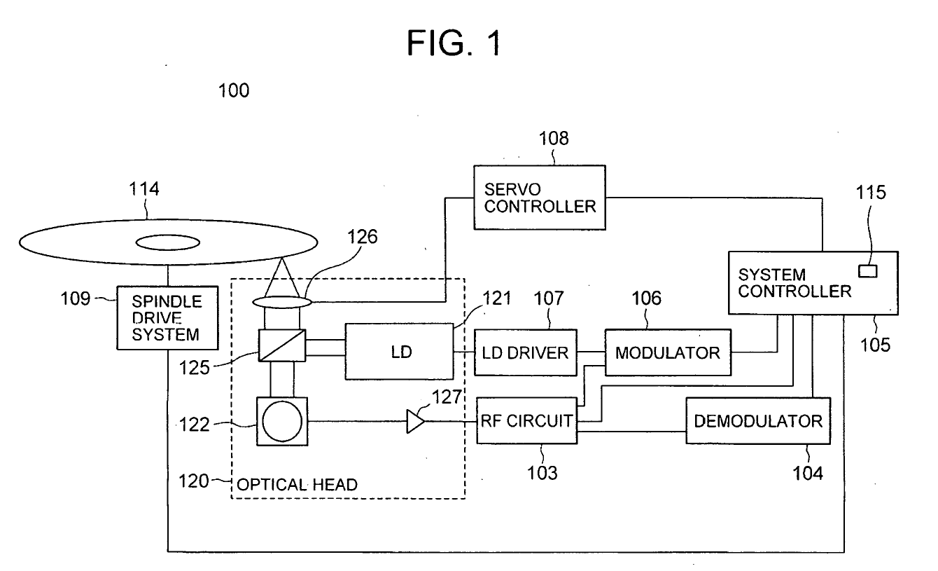

Hereinafter, exemplary embodiments of the present invention will be described in detail with reference to the accompanying drawings. FIG. 1 shows an information recording/reproducing unit (disc drive) according to a first exemplary embodiment of the present invention. The disc drive 100 includes an RF circuit 103, a demodulator 104, a system controller 105, a modulator 106, a LD driver 107, a servo controller 108, a spindle drive system 109, and an optical head 120. An optical disc 114 is a recordable medium, e. g. a write-once disc that enables recording thereon only once. The disc drive 100 performs recording data on the optical disc 114, and reproducing the data from the optical disc 114.

The optical head 120 includes a laser diode (LD) 121, a photodetector 122, and a beam splitter 125. The laser diode 121 emits light used for performing recording/reproducing on the optical disc 114. The beam splitter 125 reflects the light incident from the laser diode 121 toward the optical disc 114. The light reflected by the beam splitter 125 is focused by an objective lens 126 onto a recording film of the optical disc 114.

The light focused onto the recording film of the optical disc 114 is again incident onto the beam splitter 125. The beam splitter 125 passes therethrough the light incident from the optical disc 114 to the photodetector 122. The photodetector 122 converts the light passed by the beam splitter 125 into an electric signal. The electric signal converted by the photodetector 122 is amplified by a preamplifier 127, to be supplied to the RF circuit 103.

The spindle drive system 109 rotates the optical disc 114. The RF circuit 103 generates a binary signal from the input signal. The RF circuit 103 performs filtering processing etc. onto the input signal, measures the signal quality thereof, and outputs an index value showing the signal quality of the reproduced signal to the system controller 105. The demodulator 104 demodulates data from the binary signal generated by the RF circuit 103 in accordance with a specific demodulation rule, and outputs the demodulated data to the system controller 105.

The modulator 106 modulates a recording signal under a specific modulation rule. The LD driver 107 drives the laser diode 121 in the optical head 120 based on the output signal from the modulator 106. The output signal from the modulator 106 is input also to the RF circuit 103, which uses the input signal for measuring the signal quality. The servo controller 108 generates a servo signal. The system controller 105 controls the disc drive 100 as a whole.

The system controller 105 includes therein a parameter calibration section 115. The parameter calibration section 115 has a function of controlling calibration of the recording strategy including the peak power, and bias power. The parameter calibration section 115 recognizes the correspondence between the recording condition and the signal quality based on the signal quality output from the RF circuit 103, such as the PRSNR, error rate and asymmetry, and the number of PI errors obtained from the reproduced data pattern demodulated by the demodulator 104, and controls the calibration sequence, thereby performing calibration of the parameters so as to perform a suitable recording.

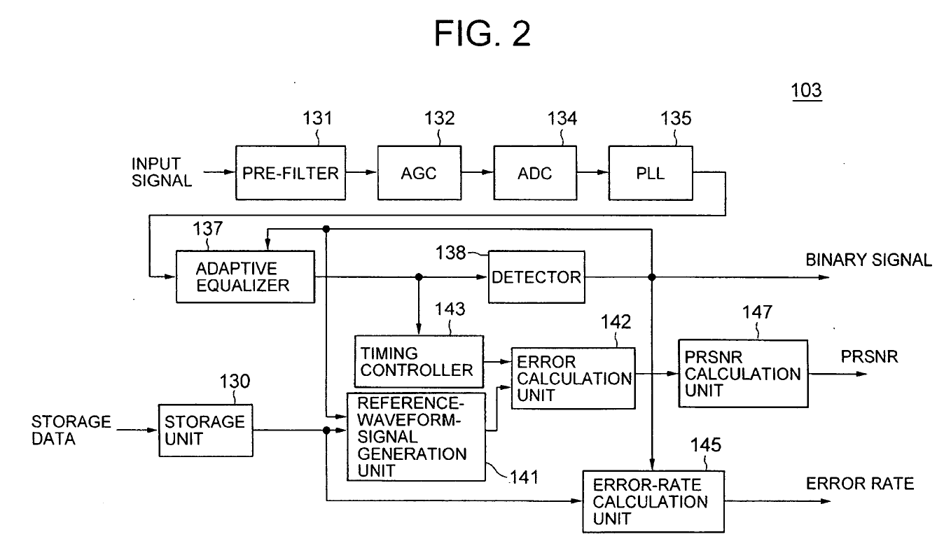

FIG. 2 shows the configuration of RF circuit 103. The RF circuit 103 includes a storage unit 130, a pre-filter 131, an automatic gain control (AGC) circuit 132, an A/D converter (ADC) 134, a PLL (phase locked loop) circuit 135, an adaptive equalizer 137, a detector 138, a reference-waveform-signal generator 141, an error calculation section 142, a timing controller 143, an error-rate calculation section 145, and a PRSNR calculation section 147.

The pre-filter 131 passes therethrough the signal input from the optical head 120 while filtering the same. The AGC circuit 132 controls the amplitude of the filtered signal. The A/D converter 134 converts into the digital data the input signal for which the amplitude is controlled. The PLL circuit 135 extracts a clock signal based on the digital data. The digital data output form the A/D converter 134 is synchronized with the channel clock frequency by the PLL circuit 135, and output to the adaptive equalizer 137.

The adaptive equalizer 137 performs equalization of the input signal so that the input signal becomes close to a desired partial response characteristic, to output an equalized reproduced signal having a modified frequency characteristic. The adaptive equalizer 137 includes therein an FIR filter (finite-impulse-response filter). The adaptive equalizer 137 determines a tap coefficient of the FIR filter by using a LMS (least mean square) algorithm, and adaptively modifies the frequency characteristic of the input signal.

The detector 138 receives the equalized reproduced signal from the adaptive equalizer 137, to generate binary data based on the equalized reproduced signal. The detector 138 includes therein a Viterbi decoder. The detector 138 selects a path having a minimum Euclid distance from the equalized reproduced signal, to output a coded bit sequence corresponding to the selected path as binary data signal (estimated data pattern). The binary data signal is input to the demodulator 104 (FIG. 1), and fed back to the adaptive equalizer 137.

The reference-waveform-signal generator 141 generates an ideal signal waveform by using vector convolution of the PR class. The reference-waveform-signal generator 141 generates an ideal signal waveform by the vector convolution of (1,2,2,2,1) for the case of PR (1,2,2,2,1) class, for example. The input of the reference-waveform-signal generator 141 is provided with a path selector (not illustrated), which selects the binary data signal output from the detector 138 or the data stored in the storage unit 130 as the input of the reference-waveform-signal generator 141. The reference-waveform-signal generator 141 generates the ideal signal waveform based on the binary data signal output from the detector 138. In an alternative, the reference-waveform-signal generator 141 generates the ideal signal waveform based on the recording data pattern which is stored in the storage unit 130 and has been used for recording or to be used for recording.

The error calculation section 142 calculates the difference (equalization error signal) between the ideal signal waveform generated by the reference-waveform-signal generator 141 and the equalized reproduced signal for which the input timing is adjusted by the timing controller 143. The PRSNR calculation section 147 calculates the PRSNR by using the equalization error signal output from the error calculation section 142 as the noise which is needed each time calculation of the PRSNR is to be performed. The error-rate calculation section 145 compares the output from the detector 138 against the data pattern stored in the storage unit 130 based on the timing signal (not shown) input from the system controller 105, and calculates the error rate. The PRSNR and error rate (reproduced-signal quality) thus calculated are input to the system controller 105, and used as the signal evaluation index. The number of error bytes in a predetermined ECC (error correction code) block may be used as the signal evaluation index.

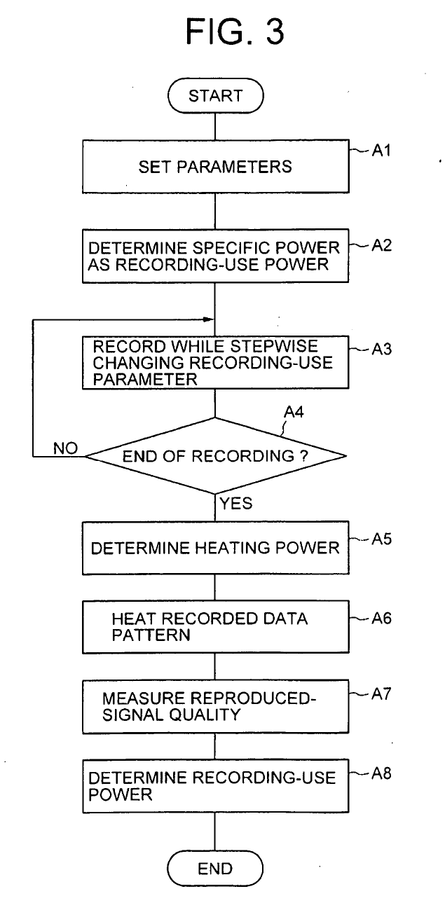

FIG. 3 shows the procedure of calibrating the optical irradiation power (recording condition). The disc drive 100, upon loading of an optical disc 114, starts calibration of the optical irradiation power. The system controller 105 moves the optical head 120 to a system data area of the optical disc 114. The disc drive 100 reads out information of the disc manufacturer, and obtains information including the type of disc, name of disc manufacturer, etc. from the system data area of the optical disc 114 based on the information. The disc drive 100 obtains a parameter table for the medium based on the type of the disc, name of the disc manufacturer, etc. thus acquired. The parameter calibration section 115 of the system controller 105 sets a variety of parameters (peak power, bias power, bottom power, etc.) based on the acquired parameter table (step A1).

The parameter calibration section 115 selects the power set in step A1, which is referred to as specific power hereinafter, for the recording-use power (step A2). The parameter calibration section 115 iteratively records a specific data pattern by using a plurality of recording conditions that are obtained by stepwise changing power from the specific power and a preceding power (step A3). The parameter calibration section 115 judges whether or not all the recording powers within a specific range are used for the recording (step A4). If it is judged that all the recording conditions are not yet used for recording, the parameter calibration section 115 returns to step A3, wherein the recording of the specific data pattern is performed using another recording power obtained by stepwise changing the power from the preceding recording power.

The recording in step A3 is performed by an ECC block, for example, as a unit. The parameter calibration section 115 stepwise changes the power after recording an ECC block, and performs the recording of a plurality of ECC blocks. In an alternative, the recording may be performed by several sectors as a unit, instead of the ECC block. A single sector may include 26 synchronous frame as in the case of HD DVD, for example. The parameter calibration section 115, upon completing recording of the specific data pattern, determines the heating power, i.e., power for heating the recorded area of the specific data pattern by using optical irradiation (step A5). The parameter calibration section 115 irradiates the recorded area of the specific data pattern recorded with the laser beam having the power determined in step A5, to heat the recorded, specific data pattern (step A6).

The irradiation (heating) by the laser beam in step A6 is performed in order to supply a heat load to the recorded pattern. Accordingly, the heating power should be lower than the recording power (peak power) that is used for recording the mark in the specific data pattern. On the other hand, the irradiation should have a heating power that is sufficient to apply a significant heat load onto the recorded data pattern. The parameter calibration section 115 may determine the heating power in step A5 based on the bias power set in step A1. This is because the bias power is considered to affect the formation of the mark and yet be lower than the level that forms the mark by itself, and thus the bias power is roughly equivalent to the level required of the heating power. The parameter calibration section 115 may determine a power within a range around from a 30%-decreased level to a 15%-increased level from the bias power as the heating power of optical irradiation that heats the recorded specific data pattern. The 30%-decreased level to a 15%-increased level (from the reference power) will be referred to as −30%- to +15%-increased level hereinafter, and the same applies to other similar cases.

The parameter calibration section 115 reproduces the recorded specific data pattern after the heating thereof, and receives the results of measuring a reproduced-signal quality from the RF circuit 103 (step A7). The parameter calibration section 115 determines the laser power, i.e., recording-use power, for irradiating the optical disc 114 upon recording the mark thereon, based on the results of measuring the reproduced-signal quality (step A8). The parameter calibration section 115 selects in step A8 one of the recording powers that records the specific data pattern providing a reproduced signal having a highest reproduced-signal quality, for example, among the reproduced signal qualities measured for the reproduced signals reproduced from the specified data patterns recorded using all the recording powers.

Hereinafter, operation of the present embodiment will be described based on a concrete example. A write-once medium (HD DVD-R) among the media satisfying the HD DVD standard is exemplified as the optical disc 114 in this example. This optical disc 114 is such that the recording film therein includes an organic pigment and a recorded mark has a higher reflectance than an unrecorded area. This type of the medium is referred to as low-to-high medium. The optical disc 114 includes a transparent substrate having a thickness of 0.6 mm and a diameter of 12 cm. The transparent substrate is made of polycarbonate and provided with a guide groove thereon referred to as pre-groove.

The disc drive 100 performs recording/reproducing by scanning optical disc with the laser beam along the guide groove. The disc drive 100 irradiates the laser beam onto the recording film formed on the substrate, to record a specific data pattern. The laser beam emitted by the laser diode 121 has a wavelength of 405 nm, and the objective lens 126 of the optical head 114 has a NA (numerical aperture) of 0.65. The physical format of the optical disc 114 is an in-groove format wherein the pit pitch is 0.1 μm and the track pitch is 0.40 μm. An ETM (eight-to-twelve modulation) code is used as the modulation/demodulation code for the data pattern recorded on the recording film of the optical disc 114. A reproducing power of 0.4 mW is used for reproducing the specific data pattern in the disc drive 100.

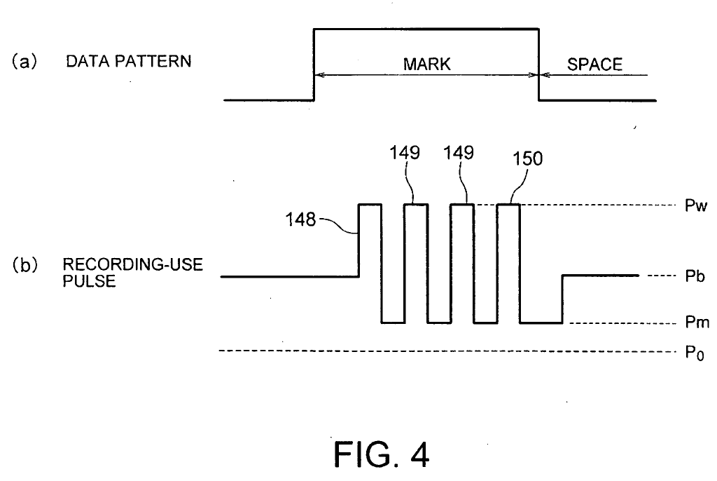

The disc drive 100 uses a recording strategy including a (k−1)-pulse train for forming a mark. FIG. 4(a) exemplifies a NRZI (non-return-to-zero inversion) pattern to be recorded, and FIG. 4(b) exemplifies the waveform of the (k−1)-pulse train. The recording strategy shown in FIG. 4(b) corresponds to the NRZI pattern, and has a peak power Pw and a bottom power Pm corresponding to the mark portion, and a bias power Pb corresponding to the space portion.

The (k−1)-pulse train has (k−1) pulses for recording a kT mark (T is a channel clock frequency and k is an integer corresponding to the length of the mark). The number, k, used in the ETM modulation technique is not less than two because the shortest mark therein is a 2 T mark. The waveform in FIG. 4(b) including four pulses corresponds to a 5 T mark, wherein the four pulses include a top pulse 148, two intermediate pulses 149 and an end pulse 150.

Upon loading of the optical disc 114 onto the disc drive 100, the system controller 105 reads out “disc manufacturing information” from a system data area, to obtain the type of disc, name of the manufacturer, etc. based on the disc manufacturing information. The system controller 105 judges that the optical disc 114 is of a low-to-high type HD DVD-R of the HD DVD standard based on the thus obtained information.

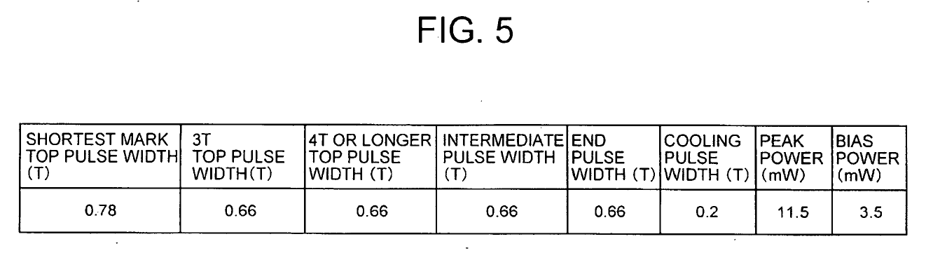

The parameter calibration section 115 reads out in step A1 (FIG. 3) the parameter table corresponding to the loaded optical disc 114, and sets a variety of parameters. FIG. 5 shows an example of the parameter table. The information of this parameter table is recorded on the optical disc 114. In an alternative, the disc drive 100 may store therein the parameter table for each of a variety of media, read the corresponding parameter table based on the type of disc, name of the disc manufacturer, etc. that are read out.

The parameter calibration section 115 sets the peak power at 11.5 mW and the bias power at 3.5 mW based on the parameter table shown in FIG. 5. The bottom power is fixed at 0.1 mW. The parameter calibration section 115 also performs setting of parameters, other than the above powers, including top pulse width, intermediate pulse width, end pulse width, and cooling pulse width.

The parameters other than the powers may be determined based on the information of parameters stored in the disc drive without using the information stored in the optical disc.

The parameter calibration section 115 sets in step A1 the number of steps for changing the recording power and the range within which the recording-use power is to be changed, other than the above parameters. The parameter calibration section 115 may set a ±20% increase from the initial recording-use power (0%-increased level) for the range within which the recording-use power is to be changed from the initial recording-use power, for example.

The step of changing the recording-use power may be set at 10%, in this example. The step of changing the power and the variable range may be stored in the disc drive corresponding to each of the optical discs.

In step A2, the parameter calibration section 115 determines the peak power at 11.5 mW and the bias power at 3.5 mW, which are determined in step A1, in the recording-use power. The disc drive 100 uses the drive test zone as the OPC (optical power control) area, in which the disc drive 100 reads and write data as desired for calibration of a variety of parameters, such as the recording-use power. The system controller 105 moves the optical head 120 to the drive test zone of the optical disc 114, thereby performing the recording in step A3.

The parameter calibration section 115 iterates the step A3 and step A4, to perform recording while stepwise changing (decreasing) the recording power and bias power by a step of 10% from a 20%-increased level of the power determined in step A2. The parameter calibration section 115 performs recording by the ECC block as a unit, while changing the power for the ECC block from a preceding ECC block. Since the 0%-increased level of the peak power and bias power corresponds to 11.5 mW and 3.5 mW, respectively, the parameter calibration section 115 uses a plurality of combinations of the peak power and bias power while changing the peak power within a range between 13.8 mW and 9.2 mW, and the bias power within a range between 4.2 mW and 2.8 mW, for recording the specific data pattern.

The parameter calibration section 115 selects in step A5 one of the bias powers of the laser beam used in step A3 for recording the specific data pattern while changing the recording-use power, as the heating laser power for irradiating the recorded specific data pattern. The parameter calibration section 115 determines 3.5 mW, for example, which is a 0%-increased level of the bias power as the heating-use laser irradiation power. The parameter calibration section 115 irradiates in step A6 a 3.5-mW laser beam onto the recorded specific data pattern recorded in step A3, to heat the recorded specific data pattern at a fixed heating power.

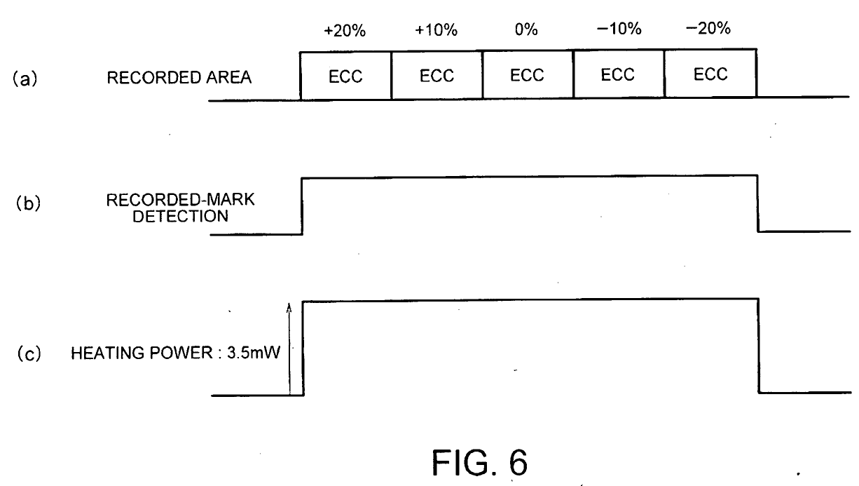

FIG. 6 shows the way of heating in step A6. FIG. 6(a) shows the recorded area of the specific data pattern, including five ECC blocks wherein the first ECC block is recorded using a peak power which is an 20%-increased level of the specific power, the second ECC block is recorded using a 10%-increased level of the specific power, i.e., using the peak power which is 10% less than the peak power used in the first ECC block, and succeeding ECC blocks are recorded using a recording power reduced by 10% of the specific recording power from the preceding ECC block. FIG. 6(b) shows the detection signal for detecting the recorded area of the specific data pattern, and FIG. 6(c) shows the heating power which is 3.5 mW in this example for the recorded ECC blocks.

More specifically, the parameter calibration section 115 instructs the LD driver 107 (FIG. 1) to set the heating power at 3.5 mW, when the laser beam is guided along the recording track. Since the LD driver 107 drives the LD 121 at 3.5 mW, a 3.5 mW laser beam is irradiated onto to the ECC blocks recorded in step A3, to apply a heat load to the ECC blocks.

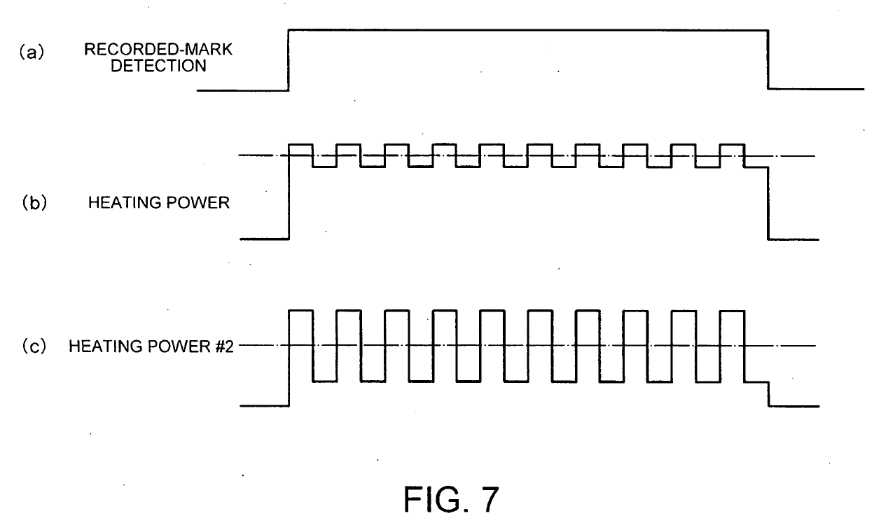

In step A6, it is sufficient to heat the recorded specific data pattern at a constant heating power, and it is not needed to maintain the laser power at a constant power. FIG. 7 shows other examples of the heating in graphs (b) and (c) together with the detection signal of the recorded area shown in (a). The heating powers shown in (b) and (c) modulate the laser power so that the average laser power shown by the one-dotted-chain line provides the specific heating power. In this case, the laser power is controlled so that the average heating power assumes the heating power determined in step A5.

The parameter calibration section 115 reproduces in step A7 the recorded specific data pattern heated in step A6, and measures the reproduced-signal quality in each area. The parameter calibration section 115 determines in step A8 the recording-use parameter (combination of the peak power and bias power) based on the results of measuring the reproduced-signal quality. FIG. 8 shows an example of the results of measuring the signal quality. In this example, a PRSNR is used as the reproduced-signal quality. In the results of measuring the reproduced-signal quality shown in FIG. 8, the PRSNR assumes an optimum value for the combination of 10%-increased levels of the specific power. The parameter calibration section 115 determines in step AS the peak power at 12.7 mW and the bias power at 3.9 mW corresponding to the 10%-increased level of the specific power of the recording-use power.

In the above exemplary embodiment, the optimum combination that provides a highest reproduced-signal quality is selected from among the combinations of peak power and bias power used in the recording step A3. However, the combination of the peak power and bias power in the recording-use power may be selected based on the results of measuring the reproduced-signal quality from among a plurality of parameters that provide a specific reproduced-signal quality or higher. Determination of a parameter from a plurality of parameters may select an average or median of the plurality of parameters that provide the specific reproduced-signal quality or higher, or may select a parameter close to the average or median. The parameter calibration section 115 may select the optimum parameter that provides an optimum reproduced signal by using interpolation in consideration of the step of setting the parameter.

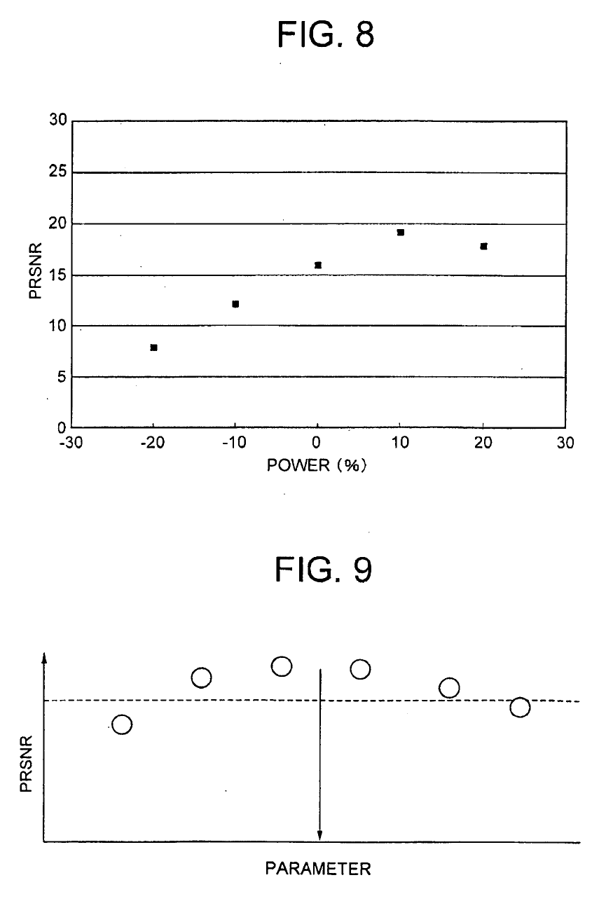

FIG. 9 shows an example of determining the recording-use power from among a plurality of parameters. The parameter calibration section 115 obtains a range of parameters that provide the specific reproduced-signal quality or higher. In this case, it is assumed that the specific reproduced-signal quality is PRSNR=20. In the example of FIG. 9, there are four parameters that provide the specific reproduced-signal quality PRSNR=20 or higher. The parameter calibration section 115 calculates the average of the four parameters, to determine the average value in the recording-use power. In this way, a parameter sandwiched between two lower parameters and two higher parameters that provide the specific reproduced-signal quality PRSNR=20 can be selected in the recording-use power.

FIG. 10 shows results of measuring the reproduced-signal quality after an accelerated environmental test. For the feasibility of comparison with the results shown in FIG. 8, the recording was performed onto the disc of the same format while changing the peak power and bias power by a 10% step within the range of a ±20%-increased level from the specific recording power with the center of range being at a 0%-increased level, i.e., at 11.5 mW and 3.5 mW for the peak power and bias power, respectively. Thereafter, as the accelerated environmental test, the disc was maintained under the accelerated environment including an RH (relative humidity) of 60% and an ambient temperature of 80 degrees C. for 500 hours. The disc was then subjected to reproduction of the recorded area for measuring the PRSNR.

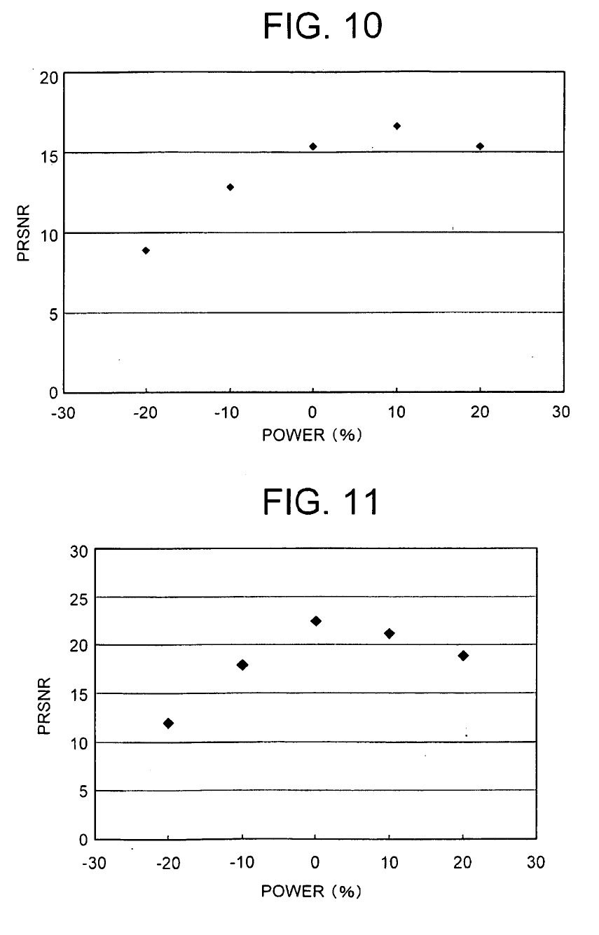

FIG. 11 shows the PRSNR measured before the accelerated environmental test and plotted with respect to the recording-use power. The condition for measuring the PRSNR of FIG. 11 is similar to that of FIG. 10. Comparing both the PRSNRs before and after the accelerated environmental test, it is understood that the 0%-increased level of the recording-use power provides the highest reproduced-signal quality before the accelerated environmental test, whereas the 10%-increased level of the recording-use power provides a highest reproduced-signal quality after the accelerated environmental test. This fact means that the 10%-increased recording-use power is more preferable than the 0%-increased recording-use power with respect to the highest reproduced-signal quality after the accelerated environmental test, for improving the archival characteristic of the recorded data.

Comparing FIG. 8 and FIG. 10, the parameter providing an optimum PRSNR in FIG. 8 coincides with the parameter providing an optimum PRSNR in FIG. 10 measured after the accelerated environmental test. This fact means that addition of the heating step (step A6) to apply the heat load to the recorded specific data pattern followed by measuring the reproduced-signal quality to determine the recording-use power, as used in the present embodiment, can determine a recording-use power providing a higher archival characteristic even without performing the accelerated environmental test.

The present embodiment includes the steps of heating the recorded specific data pattern recorded on the optical disc 114 and reproducing the recorded data pattern after the heating step to measure the reproduced-signal quality. The step of heating the recorded data pattern to apply the heat load onto the recorded data pattern can generate the state of the recorded data pattern being subjected to the accelerated environmental test, without performing the actual accelerated environmental test. Reproduction of the recorded data pattern and measurement of the reproduced-signal quality to determine the recording-use power allows the disc drive alone to determine the recording condition that maintains the recorded data pattern having an excellent PRSNR for a longer time operation without using an accelerated environmental test system. That is, the disc drive can obtain the recording condition that prevents disappearance of the recorded data. Thus, the present embodiment allows the disc drive to obtain the recording condition that provides an excellent archival characteristic to the recorded data without using the accelerated environmental test, whereby the suitable recording condition providing the improved archival characteristic can be obtained within a short period of time and with a simple process.

A second exemplary embodiment of the present invention will be described hereinafter. The configuration of information recording/reproducing unit according to the second exemplary embodiment is similar to the configuration of the disc drive 100 in the first exemplary embodiment shown in FIG. 1. The overall procedure in the present embodiment is similar to that shown in FIG. 3. In the first exemplary embodiment, step A5 of FIG. 3 determines the optical irradiation power for heating the recorded data pattern. However, the initial recording power set in step A1 may not necessarily be a suitable power for the specific optical disc. In such a case, if the heating power is determined based on the bias power as a reference, the heating power obtained by the optical beam irradiation may not be suitable. In the present embodiment, the heating power is determined by recording a specific data pattern, heating the recorded specific data pattern, and reproducing the heated, recorded specific data pattern to measure the reproduced-signal quality. The specific data pattern used herein may be same as or different from the specific data pattern used in the first exemplary embodiment.

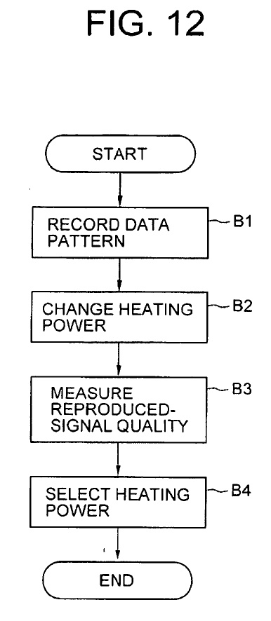

FIG. 12 shows the procedure of determining the heating power. This procedure corresponds to the step A5 in FIG. 3. In the determination of the heating power, the parameter calibration section 115 records the specific data pattern in a plurality of areas by using the specific power determined in step A2 of FIG. 3 (step B1). Subsequently, the parameter calibration section 115 heats the recorded specific data pattern recorded in the plurality of areas in step B1, while changing the heating power between areas (step B2). The parameter calibration section 115 controls the LD driver 107 (FIG. 1) to change the power of the laser beam irradiating the recorded specific data pattern between the plurality of areas, thereby heating the recorded specific data pattern with different heating powers between the areas.

The parameter calibration section 115 iterates recording of the specific data pattern to form recorded areas in number corresponding to the number of different heating powers that can be determined by the variable range and step width of the heating powers. For example, if the variable range of heating powers from the bias power determined in step A2 is ±1.0 mW and the step width of changing the heating power is 0.5 mW, the heating power is to be changed among five different heating powers. Thus, five areas are used for recording the specific data pattern corresponding to the number of different heating powers. The ECC block is selected as the unit area of recording the specific data pattern, for example. These recorded areas have a comparable performance.

The parameter calibration section 115 reproduces the recorded specific data pattern that is subjected to the heating in step B2, and measures the reproduced-signal quality for each heating power based on the reproduced signal (step B3). The parameter calibration section 115 determines the optimum heating power based on the reproduced-signal quality for each area measured in step B3 (step B4). Thereafter, the parameter calibration section 115 irradiates the recorded specific data pattern by using the laser beam having the optimum heating power determined in step B4, to heat the recorded specific data pattern with the fixed heating power.

The parameter calibration section 115, upon using the PRSNR as the reproduced-signal quality, for example, selects in step B4 the heating power that applied to the area providing a specific level of the PRSNR as the optimum heating power to be supplied in step A6. The specific level of PRSNR may preferably be 15 or less, that is generally used as the threshold of performance. In addition, it is generally known that if the PRSNR is below 8, a stable PLL is not obtained. Thus, the lower limit of the specific level is preferably 8. If the PRSNR is not used as the index of signal quality, an error rate or umber of error bytes corresponding to 8 to 15 of the PRSNR may be used for determining the heating power.

Hereinafter, operation of the present embodiment will be described with reference to a concrete example. An optical medium from a manufacturer S, which is different from the manufacturer of the optical disc used in the first exemplary embodiment, is used as the optical disc 114 in the present embodiment. The optical disc 114 in the present embodiment does not have information corresponding to the parameter table, and thus the disc drive performs setting of the parameters by using the information stored in the disc drive. It is assumed here that the peak power and bias power that are set in this case are 11.0 mW and 3.0 mW, respectively.

The parameter calibration section 115 records the specific data pattern in five ECC blocks in step B1. Thereafter, the parameter calibration section 115 heats the recorded specific data pattern in the five ECC blocks in step B2, while stepwise changing the heating power between five heating powers. Subsequently, the parameter calibration section 115 reproduces in step B3 the specific data pattern recorded in step B1, to measure the reproduced-signal quality for each ECC block.

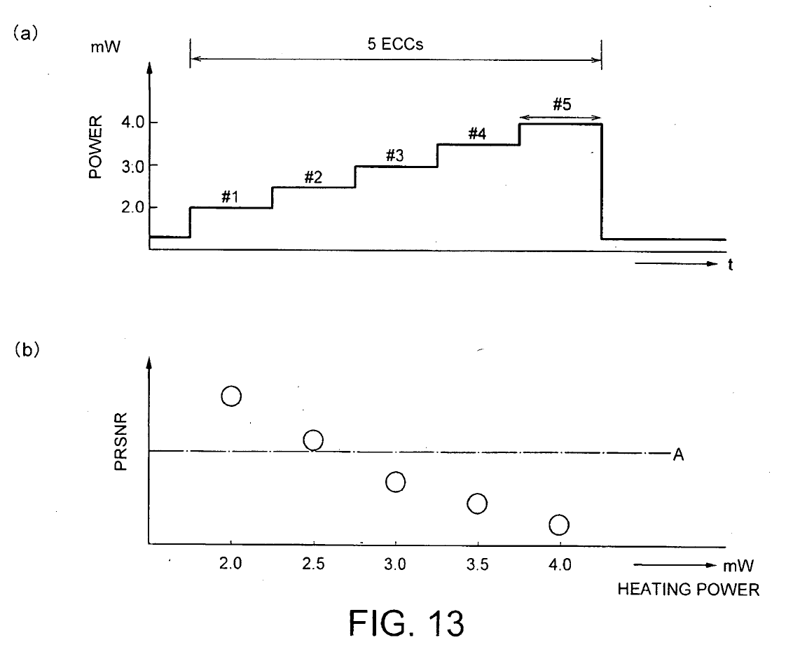

FIG. 13(a) shows the laser power used for heating the recorded specific data pattern in step B2. The parameter calibration section 115 irradiates the recorded specific data pattern in the five ECC blocks #1 to #5 with the laser beam, while stepwise changing the heating power by a 0.5-mW step within a range of 2.0 mW to 4.0 mW with the center being set at the bias power of 3.0 mW. FIG. 13(b) shows the results of measuring the reproduced-signal quality. In FIG. 13(b), the abscissa represents the heating power, whereas the ordinate represents the PRSNR of the reproduced signal. In this example, the PRSNR assumes a highest (best) value in the ECC block #1 heated at 2.0 mW, and a lowest (worst) value in the ECC block #5 heated at 4.0 mW.

The one-dot-chain line “A” in FIG. 13(b) represents a signal quality corresponding to the specific level, which corresponds to PRSNR=10. The parameter calibration section 115 determines the heating power so that the PRSNR measured in step B4 is close to the level of the one-dot-chain line, and uses the thus determined heating power as the heating power of the laser beam heating the recorded specific data pattern in step A6. In the example of FIG. 13(b), a point of the PRSNR graph that crosses the one-dot-chain line is noted, and it is found that the PRSNR for the ECC block heated at the heating power of 2.5 mW is closest to the one-dot-chain line (PRSNR=10). Accordingly, the parameter calibration section 115 determines the 2.5 mW as the heating power of the laser beam used in step A6.

The determination of heating power is not limited to the above example. For example, a point of the PRSNR graph that crosses the one-dot-chain line from above is noted and the PRSNR below (or above) and closest to the crossing point is selected for determining the heating power. In an alternative, the points above and below the crossing point may be used for determining the heating power corresponding to the crossing point by using an interpolation.

The present embodiment determines the heating power of irradiating the recorded specific data pattern based on the quality of the reproduced signal reproduced from the recorded specific data pattern. This procedure can determine the heating power corresponding to the specific combination of the disc drive and optical disc, whereby the adaptability of the heating power to the specific combination can be improved. Thus, the calibration of recording-use power can be performed with a higher accuracy, which is not affected by the specific combination of the disc drive and optical disc. In particular, if there is no corresponding optical disc on the market when the disc drive is manufactured, if there appears an optical disc on the market that is not considered as the target by the disc drive, or if the disc drive uses an optical disc for which the disc drive has no information thereof, the disc drive of the present embodiment can heat the recorded specific pattern at a suitable heating power, whereas the conventional technique cannot judge the appropriate level of the heating power to be used in step A6.

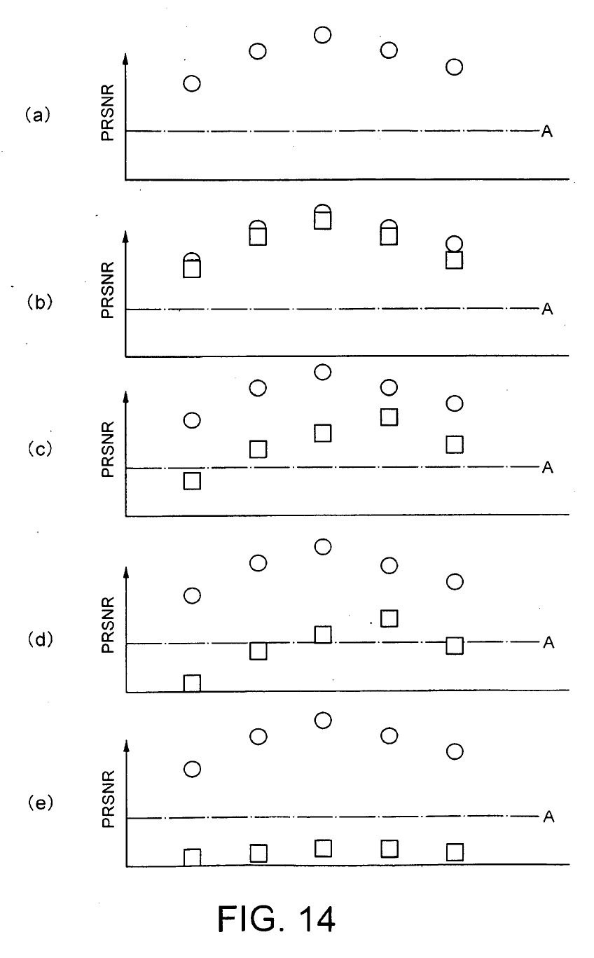

FIG. 14 presents graphs (a) to (e) showing examples of the PRSNR measured for the reproduced signals after heating the recorded specific pattern by using different heating powers. The measured PRSNR shown in FIG. 14 corresponds to the PRSNR measured in step A7 of FIG. 3. In FIG. 14, the abscissa represents the recording condition, and the one-dot-chain line “A” represents the specific level of PRSNR=10, as in the case of FIG. 13(b).

The circles in the graphs (a) to (e) in FIG. 14 represent the PRSNR measured for the reproduced signal from the recorded specific data pattern recorded while changing the recording-use power, without the step A5 of heating the recorded specific data pattern. The squares in the graphs (b) to (e) in FIG. 14 represent the PRSNR measured for the reproduced signal from the recorded specific pattern recorded while changing the recording-use power and heated by using different heating quantities. The heating power applied to the recorded specific data pattern increases from the case of graph (b) to the case of graph (e) in FIG. 14.

With reference to graphs (a) to (e) in FIG. 14, it is understood that when the recorded pattern is heated by using the different heating powers, the recording condition that provided a superior performance of the recorded mark directly after the recording cannot necessarily provide a superior performance of the recorded mark after the heating thereof, i.e., is not necessarily the recording condition that has a superior resistance to the heat load. It is also understood that if the heating power supplied to the recorded pattern is insufficient as in the case of graph (b), the performance deterioration scarcely occurs wherein the recorded pattern provides a similar PRSNR before and after the heating. Thus, this insufficient heating power cannot provide a recording condition that determines the recorded pattern having a higher resistance to the heat load. On the other hand, as understood from the graph (e) in FIG. 14, an excessive heating power that applies an excessive heat load incurs excessive performance deterioration to the recorded pattern, to thereby destroy the recorded pattern. Thus, this excessive heating power cannot provide a recording condition that determines the recorded pattern having a higher resistance to the heat load.

The graphs (c) and (d) show different absolute values of the PRSNR for the respective recording conditions; however, show the PRSNR having a similar relationship among the recording conditions. More specifically, the recording condition that provides the optimum PRSNR is the same in both the graphs. Thus, a recording condition having a higher resistance to the heat load can be obtained by selecting the heating power corresponding to the optimum PRSNR in step B4 as the heating power used in step A6. In other words, determination of the heating power by using the procedure of FIG. 12 enables selection of the heating power that suitably selects the desired recording-use power, whereby the selected heating power improves the adaptability and selection accuracy of the recording condition.

There arises a case where both the heating power corresponding to graph (c) and the heating power corresponding to graph (d) can be selected in step B4, as shown in FIG. 14. In such a case, either of these heating powers may be selected without a substantial problem in the succeeding procedure. Whether one or the other is to be selected from the plurality of heating quantities depends on the processing in the disc drive. Although it may be considered to load an algorithm program in the disc drive that automatically selects one of the heating powers, it is more preferable to determine in the design stage as to which of the heating powers should be eventually selected.

In an optical disc for which both the peak power and bias power affect the quality of recorded mark, the bias power exerts an influence on the recorded mark. This is particularly true in a write-once disc for which a laser beam having a wavelength of around 405 nm is used for recording/reproducing. Since the bias power incurs a thermal influence on such a disc, the bias power may be a target of the heat load to be applied to the recorded data pattern on the disc in step A6. If the heating power corresponding to graph (c) of FIG. 14 is equivalent to the bias power, the heating power corresponding to graph (d) of FIG. 14 is somewhat higher than the bias power. On the other hand, if the heating power corresponding to graph (d) is equivalent to the bias power, the heating power corresponding to graph (c) is somewhat lower than the bias power.

If the heating power to be used in step A6 is determined using the procedure of FIG. 12, a heating power close to the bias power can be determined by using the bias power as a rough target. It is to be noted that existence of this rough target is particularly important during finding the optimum solution. More specifically, since it is known in advance that a suitable heating power resides in the vicinity of the bias power, it is sufficient to conduct a search only in the vicinity of the bias power. The limited range of the heating power to be searched enables finding of a more accurate and suitable heating power at a higher-speed as compared to the case where the heating power is changed at random to obtain the suitable heating power without the target.

A third exemplary embodiment of the present invention will be described hereinafter. The information recording/reproducing unit according to the third exemplary embodiment has a configuration similar to that of the disc drive 100 of the first exemplary embodiment shown in FIG. 1. The overall procedure in the third embodiment is similar to that shown in FIG. 3. In the first exemplary embodiment, step A2 selects the power determined in step A1 in the recording-use power (specific power). On the other hand, in the present embodiment, step A2 for determining the recording-use power performs recording of the specific data pattern on the optical disc, and reproducing the recorded specific data pattern to investigate whether or not a desired reproduced-signal quality is obtained. This is because there is some case where the recording-use power determined in step A2 cannot necessarily provide a desired reproduced-signal quality depending on the optical disc 114.

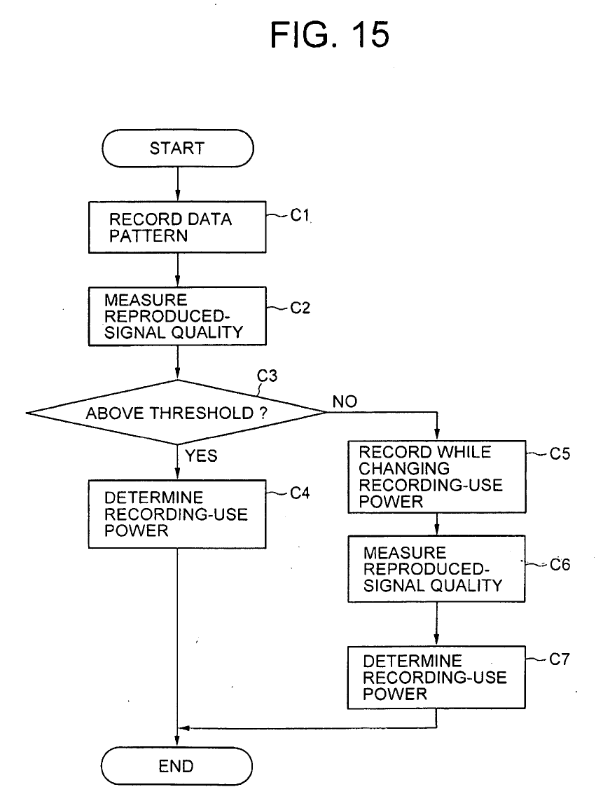

FIG. 15 shows the procedure of determining the recording-use power. This procedure is equivalent to the processing step A2 shown in FIG. 3. The parameter calibration section 115, after determining the variety of parameters in step A1, performs recording using the recording-use power determined in step A1 (step C1), and reproduces the recorded area to measure the reproduced-signal quality (step C2).

The parameter calibration section 115 compares the measured reproduced-signal quality against the desired reproduced-signal quality, to thereby judge whether or not the desired reproduced-signal quality is achieved (step C3). That is, whether or not the reproduced-signal quality measured in the reproduced signal reproduced from the recorded data pattern conforms to the desired performance is examined. The desired reproduced-signal quality is prepared and stored in the disc drive in advance for each of the types of the optical disc. If the parameter calibration section 115, upon judging in step C3 that the desired reproducing performance is satisfied, determines the power set in step A1 as the recording-use power (step C4).

The parameter calibration section 115, upon judging in step C3 that the desired reproducing performance is not satisfied, performs recording at a plurality of recording-use powers while changing the recording-use power (step C5). The parameter calibration section 115 fixes a calibration-use bias power at the bias power in the specific power set in step A1, for example, to perform recording in a plurality of areas while changing the peak power within a specific range from the specific power determined in step A1. In an alternative, the parameter calibration section 115 may perform the recording using a plurality of combinations of the peak power and bias power.

The parameter calibration section 115 reproduces the recorded areas recorded in step C5, to measure the reproduced-signal quality (step C6). The parameter calibration section 115 selects one of the powers based on the results of measuring the reproduced-signal quality, to determine the selected power as the recording-use power (step C7). The parameter calibration section 115 selects in step C7 a recording-use power that provides the highest reproduced-signal quality as a reference of determining the recording-use power in the next step.

The power determined in step C4 or C7 is used as the reference power during the recording while stepwise changing the recording-use power in step A3. For example, if the recording-use power is to be changed within a range of ±10%-increased level from the reference power during the recording in step A3, the power determined in step C4 or C7 is used as the reference power (0%-increased level).

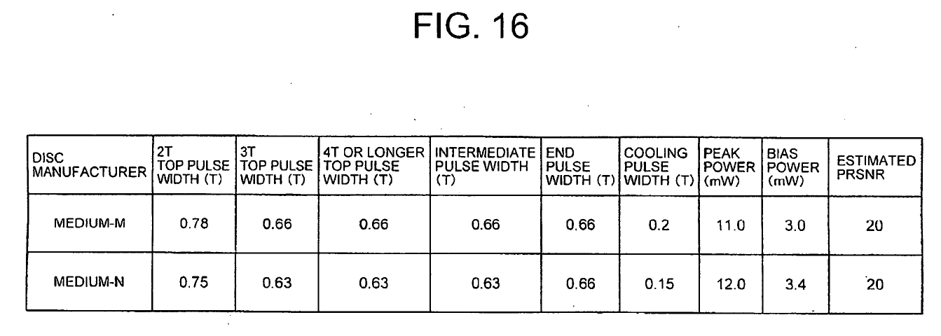

Operation of the disc drive of the present embodiment will be described based on a concrete example. In the following description, it is assumed that an optical disc (medium-M) from manufacturer-M and another optical disc (medium-N) from manufacturer-N are used as the optical discs. FIG. 16 exemplifies the parameter table in this case. This information is stored in the disc drive in advance. When the medium-M is loaded on the disc drive 100, the disc drive 100 acquires the information corresponding to the medium-M from the parameter table shown in FIG. 16. The parameter calibration section 115 sets a variety of parameters (powers) based on the acquired information (step A1 in FIG. 3).

The parameter calibration section 115 performs recording in step C1, by using the powers set in step A1, in specific recording areas. Since the recommended peak power and bias power of medium-M is 11.0 mW and 3.0 mW, respectively, in the parameter table of FIG 16, the recording in step C1 uses these powers in the recording-use power. The recording is performed by the ECC block as a unit and in four ECC blocks in this case. The parameter calibration section 115 reproduces in step C2 the recorded areas, to measure the reproduced-signal quality. The PRSNR is used as the reproduced-signal quality in this example.

The parameter calibration section 115 compares in step C3 the reproduced-signal quality measured in step C2 against the desired reproducing performance. The parameter table shown in FIG. 16 includes therein PRSNR=20 as an estimated reproduced-signal quality for the medium-M. If the reproduced-signal quality, obtained as the average of the four ECC blocks, is PRSNR=20.5, this PRSNR is higher than the estimated reproduced-signal quality PRSNR=20. Thus, the parameter calibration section 115 judges in step C3 that the desired reproducing performance is satisfied.

The parameter calibration section 115 sets in step C4 the combination of a 11.0-mW peak power and a 3.0-mW bias power in the recording-use power. The parameter calibration section 115 then performs recording of the specific data pattern in step A3 (FIG. 3) while stepwise changing the recording-use power within a specific range with the center of range being the thus set combinational power. The parameter calibration section 115 also determines in step A5 the heating power based on the bias power of 3.0 mW as a reference, whereby the disc drive irradiates the recorded specific data pattern by using the thus determined heating power.

Thereafter, the medium-M is replaced by the medium-N in the disc drive. The disc drive 100, upon loading the optical disc (medium-N) 114, acquires the information corresponding to the loaded optical disc from the parameter table of FIG. 16. The parameter calibration section 115 then sets a variety of parameters (powers) based on the acquired information.

The parameter calibration section 115 then performs recording of the specific data pattern in step C3 by using the thus set powers in the specific area. Since the estimated (or recommended) peak power and bias power of the medium-N are 12.0 mW and 3.4 mW in the parameter table of FIG. 16, the recording in step C1 uses the combination of these powers in the recording-use power. The parameter calibration section 115 reproduces in step C2 the recorded area, to measure the reproduced-signal quality.

The parameter calibration section 115 compares in step C3 the reproduced-signal quality measured in step C2 against the desired reproducing performance. The parameter table of FIG. 16 includes therein PRSNR=20 as the estimated reproduced signal of medium-N. If the reproduced-signal quality (average) measured in step C2 is PRSNR=18.5, this PRSNR is lower than the estimated PRSNR. Thus, the parameter calibration section 115 judges in step C3 that the desired reproducing performance is not satisfied.

The parameter calibration section 115, upon judging in step C3 that the desired reproduced performance is not satisfied, performs recording of the specific data pattern in step C5 in the drive test zone while changing the recording-use power. The parameter calibration section 115 stepwise changes the recording-use power within the range of a ±20%-increased level from 12.0 mW by a 5% step, for example, with the bias power being fixed at 3.4 mW, and records the specific data pattern in each ECC block. The parameter calibration section 115 reproduces the recorded areas in step C6, to measure the reproduced-signal quality for each of the recording conditions.

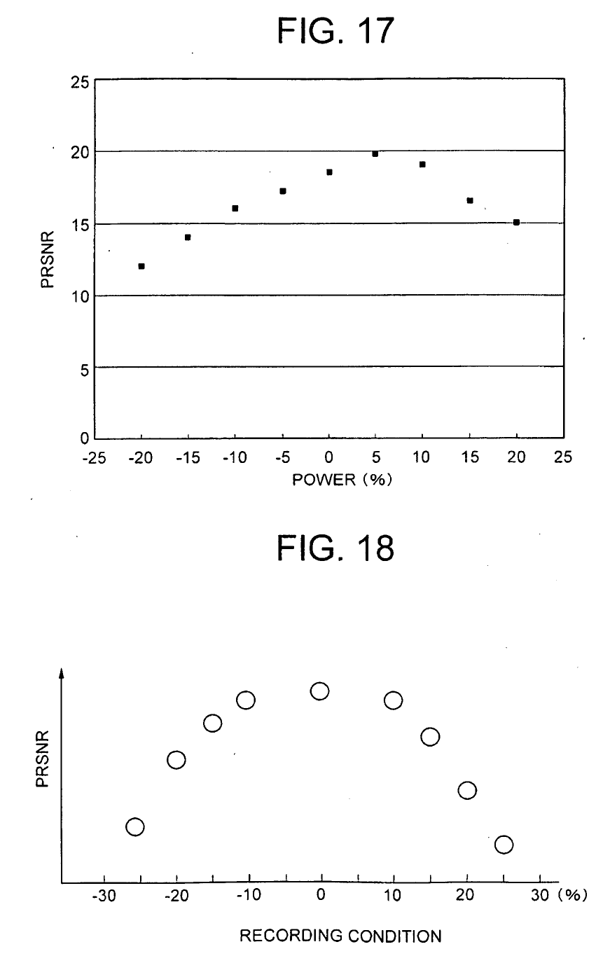

The parameter calibration section 115 determines in step C7 a recording-use power based on the results of measuring the reproduced-signal quality. FIG. 17 exemplifies the results of measuring the PRSNR. In this example, the measured PRSNR assumes a highest value when the peak power is at a +5%-increased level (12.6 mW). The parameter calibration section 115 then determines in step C7 the combination of this 12.6 mW peak power and the 3.4 mW bias power in the recording-use power. It is to be noted that the measured reproduced-signal quality need not be necessarily higher than the desired reproducing performance.

Thereafter, the parameter calibration section 115 performs recording in step A3 (FIG. 3) while stepwise changing the recording-use power with the combination of 12.6-mW peak power and 3.4-mW bias power being the center. The parameter calibration section 115 also determines in step A5 the heating power based on the bias power of 3.4 mW set in step C7 as the reference.

In the present embodiment, the parameter calibration section 115 judges, before calibration of the recording-use power for an optical disc, whether or not the desired reproducing performance is obtained by the current recording-use power. If it is judged that the desired reproducing performance is not obtained, recording of a specific data pattern is performed on the optical disc 114 to find a recording condition that provides a higher reproducing performance. In this way, calibration of the recording-use power by using a recording-use power that provides a lower reproducing performance can be avoided, whereby a higher calibration accuracy can be obtained.

The reason of performing the judgment as to whether or not the current recording-use power provides the desired reproducing performance in calibration of the recording-use power is that an estimated device performance and/or disc characteristic is not necessarily obtained depending on the combination of the disc drive and the optical disc device. If the estimated device performance and/or disc characteristic is not obtained, it is not assured whether or not the specific data pattern used for recording has a desired performance in the calibration. In this case, the recording-use power calibrated by recording such a data pattern and applying the heat load to the recorded data pattern cannot necessarily generates a recorded mark having a superior archival characteristic. This may lead to an abnormal result or an only locally-optimized result. This may also lead to a deficiency of versatility over a wide variety of combinations of disc drive and optical disc. In the present embodiment, it is judged whether or not the recording condition provides a desired performance, and if it is judged that the desired performance cannot be obtained therefrom, an investigation is performed to find the recording condition having a performance as high as possible, whereby a subsequent processing accuracy can be assured. In addition, the versatility can be also assured without depending on the specific combination of the disc drive and the optical disc.

In the above exemplary embodiments, the recording-use power is stepwise changed by a constant step; however, the step for the change of power may be varied as desired. In addition, the step of changing the heating power is not necessarily constant, and may be varied as desired. For example, the peak power and bias power may be changed from a +25%-increased level (12.0 mW and 3.0 mW), through +20%-, +15%-, +10%-, 0%-, −10%-, −15%- and −20%-increased levels down to a −25%-increased level. In this example, the steps of 10% and of 5% are used between 0% and ±10% and between 10% and 25%, respectively.

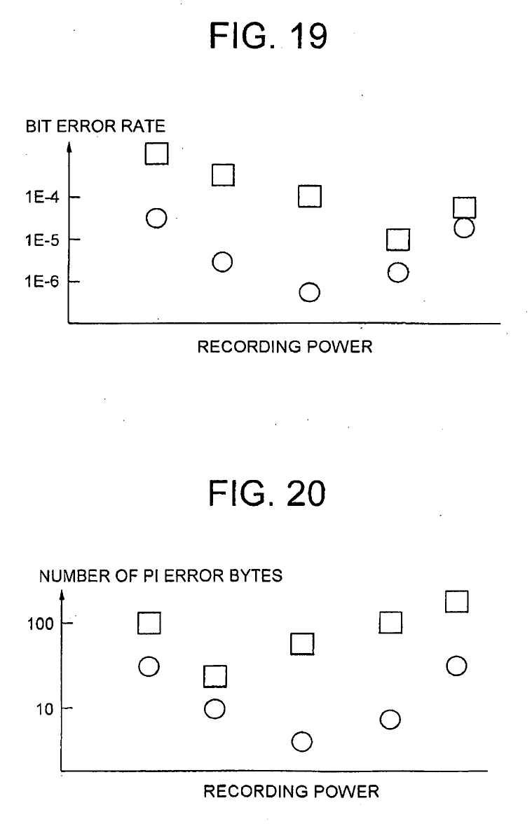

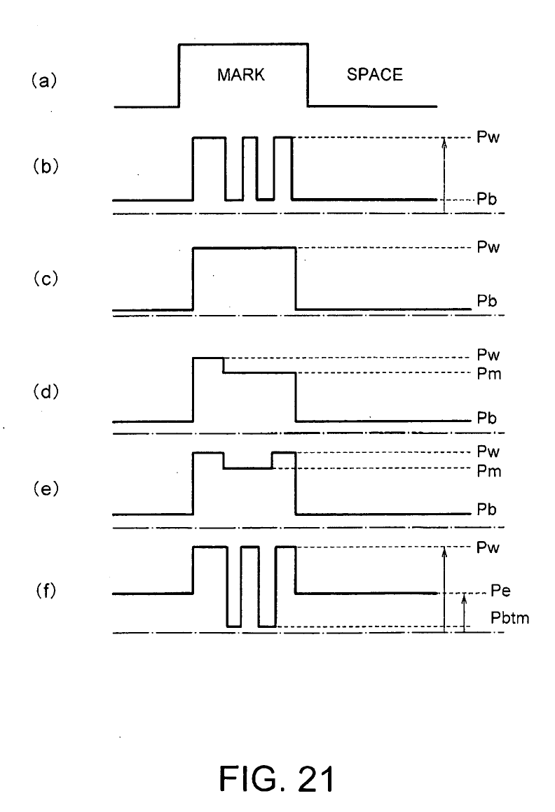

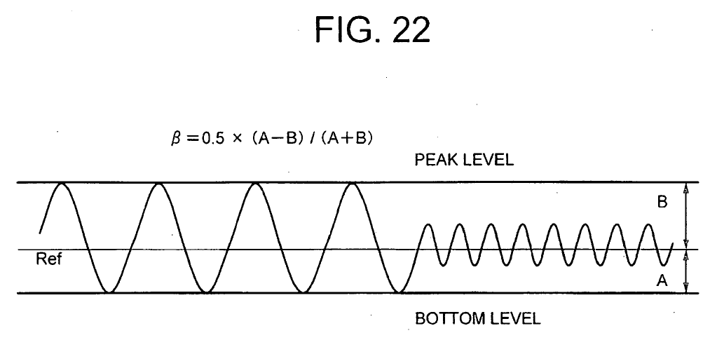

FIG. 18 exemplifies the results of PRSNR measured while changing the recording-use power. As understood in FIG. 19, the change rate of PRSNR is smaller in the vicinity of 0%-increased level of the recording-use power, i.e., the vicinity of 12.0mW and 3.0 mW. By employing a larger step at which the PRSNR has a lower change rate and a smaller step at which the PRSNR has a higher change rate, a coarse investigation is performed for a portion of the smaller characteristic change, whereas a fine investigation is performed for a portion of the larger change rate. This enables a higher-speed processing and reduces the area of the consumed drive test zone.

In the above, exemplary embodiments, recording of the specific data pattern is performed to measure the reproduced-signal quality by performing calibration of the recording-use power (FIG. 3), determination of the heating power (FIG. 12) and determination of the specific power (FIG. 15). However, if a data pattern having a certified quality is stored in the drive test zone etc. of the optical disc 114 for use in calibration of the recording-use power, the stored data pattern may be used for calibration of the recording-use power, determination of the heating power and determination of the specific power. Use of the existing data pattern reduces the burden of the disc drive for the recording operation, thereby allowing a higher-speed processing and saving the calibration area.

If use of the existing data pattern is intended in the disc drive, the disc drive first judges whether or not a data pattern that can be used for the calibration is stored in the drive test zone. If there is an existing data pattern therein, use of the existing data pattern is determined after judging whether or not the existing data pattern satisfies the specific quality level. If there is no existing data pattern or the existing data pattern does not satisfy the specific quality level, then recording of the specific data pattern is performed on the optical disc and calibration is executed using the recorded data pattern.

In the above exemplary embodiments, an optical head having a laser wavelength of 405 nm and an NA (numerical aperture) of 0.65 for the object lens is used. However, calibration of the recording-use power is not limited to the above laser wavelength and NA. The optical disc 114 used in the above embodiments is of an HD DVD standard; however, the optical disc 114 may be of other standards such as a Blu-ray Disc (BD disc). The optical disc 114 is not limited to one including an organic-pigment recoding film, and may include an inorganic-pigment recording film. The optical disc including the inorganic-pigment recording film may be a high-to-low medium wherein a recorded mark on the medium has a lower reflectance than an unrecorded section.

The equalization class of the PRML detection technique using the PRSNR may be PR (1,2,2,2,1) or PR (1,2,2,1) class, for example. The modulation code used in the present embodiment may be other than the ETM that is on the basis of (1, 7) RLL code. In such a case, the shortest data length may be 3 T ( T is a channel clock frequency). The recording strategy may be other than the (k−1)-type pulse train.

The PRSNR is used in the embodiments as the performance index of the reproduced-signal quality; however the PRSNR may be replaced by other indexes such as the error rate, number of PI error bytes, or other indexes that are qualitatively equivalent to the error rate. The other indexes include SAM (sequenced amplitude margin) and an SAM-based index.

FIG. 19 exemplifies results of measuring the bit error rate as the reproduced-signal quality, wherein the abscissa represents the recording-use power. In FIG. 19, the circle represents the reproduced-signal quality before heating the recorded data pattern in step A6, whereas the square represents the reproduced-signal quality after the heating. A smaller bit error rate means a higher reproducing performance. It will be understood from FIG. 19 that use of the bit error rate as the reproduced-signal quality also enables determination of the recording-use power that provides a higher archival characteristic if the recording-use power is determined based on the quality of the reproduced signal reproduced from the heated, recorded data pattern.

FIG. 20 exemplifies the results of measuring the number of PI error bytes in respective data blocks, i.e., ECC blocks in this example, as the reproduced-signal quality. The abscissa represents the recording-use power. The notation of circle and square is similar to that in FIG. 19. A smaller number of PI error bytes means a higher reproducing performance. It is understood from FIG. 20 that the recording-use power providing the highest reproduced-signal quality is different between before and after heating the recorded data pattern. Thus, it is assured that use of the number of PI error bytes as the reproduced-signal quality also enables determination of the recording-use power that provides a higher archival characteristic if the recording-use power is determined based on the quality of the reproduced signal reproduced from the heated, recorded data pattern.

Calibration of the recording-use power including the peak power and bias power is exemplified as the parameter of the recoding condition in the above embodiments. However, calibration in the present invention is not limited to this example, and may be 15 applied to other parameters generally used in the recording condition. In this case, the step A3 in FIG. 3 performs recording while changing the target parameter to obtain a plurality of recording conditions, and the step A8 determines the recording-use condition based on the reproduced-signal quality.

While the invention has been particularly shown and described with reference to exemplary embodiment and modifications thereof, the invention is not limited to these embodiment and modifications. It will be understood by those of ordinary skill in the art that various changes in form and details may be made therein without departing from the spirit and scope of the present invention as defined in the claims.

What is claimed is:

1. A method for calibrating a recording condition in an information recording unit that performs recording on an optical information recording medium for which a mark is recorded by optical beam irradiation, said method comprising:
heating a first recorded data pattern recorded on the information recording medium;
reproducing said first recorded data pattern after said heating, to measure a reproduced-signal quality; and
determining a desired recording condition based on the measured reproduced-signal quality.

2. The method according to claim 1, wherein said heating applies a significant heat load to said first recorded data pattern.

3. The method according to claim 1, further comprising recording said first recorded data pattern by using a plurality of first recording-use conditions prior to said heating, wherein said determining determines said recording-use condition based on a relationship between reproduced-signal qualities measured for said first recorded data pattern recorded using said first recording-use conditions and said first recording conditions.

4. The method according to claim 3, wherein said determining selects, as said desired recording-use condition, one of said first recording-use conditions that provides a highest reproduced-signal quality among said first recording-use conditions.

5. The method according to claim 3, wherein said first recording-use conditions each include a peak power and a bias power corresponding to a mark and a space, and said recording records said first recorded data pattern by using a plurality of combinations of said peak power and said bias power as respective said first recording-use conditions.

6. The method according to claim 5, wherein said heating irradiates an optical beam having a power equal to said bias power of one of said combinations.

7. The method according to claim 3, further comprising, prior to said recording, selecting a reference power that is a reference used for determining said first recording-use powers.

8. The method according to claim 7, wherein said recording-use powers are obtained by stepwise changing said reference power, with said reference power being a center of changing.

9. The method according to claim 7, wherein said reference power selecting comprises recording a first data pattern on the optical information medium by using a second recording-use power, measuring a reproduced-signal quality of a reproduced signal from said recorded first data pattern, and determining said second recording-use power as said reference power if said reproduced-signal quality is above a specific level.

10. The method according to claim 7, wherein said reference power selecting comprises recording a first data pattern on the optical information medium by using a plurality of second recording-use powers, measuring a reproduced-signal quality of said recorded first data pattern for each of said second recording-use powers, and selecting one of said second recording-use powers based on said reproduced signal quality.

11. The method according to claim 10, wherein said selecting of said one of said second recording-use powers selects said one of said second recording-use powers that provides a highest reproduced-signal quality among said plurality of said second recording-use power.

12. The method according to claim 1, further comprising selecting, prior to said heating, a heating power for said heating.

13. The method according to claim 12, wherein said heating power selecting comprises heating a second recorded pattern, measuring a reproduced-signal quality from said heated second recorded pattern, and determining said heating power based on said reproduced signal quality measured for said second recorded data pattern.

14. The method according to claim 13, wherein said heating power selecting, as said heating power, a specific heating power that allows said second recorded data pattern to provide a reproduced-signal quality that is below a specific level after said heating of said second recorded pattern.

15. The method according to claim 1, wherein said reproduced-signal quality includes one of a PRSNR and an error rate.

16. An information recording unit that records a mark on an information recording medium by using optical irradiation, comprising:
a parameter calibration unit that heats a first recorded data pattern recorded on the information recording medium, reproduces said first recorded data pattern after said heating, to measure a reproduced-signal quality, and determines a desired recording condition based on the measured reproduced-signal quality.
